(19) United States
(12) Patent Application Publication
(10) Pub. No.: US 2024/0270963 A1
(43) Pub. Date: Aug. 15, 2024

(54) Multi-Purpose Polyamide Polymer Composition and Housings For Electric Vehicles Made Therewith

(71) Applicant: Celanese International Corporation, Irving, TX (US)

(72) Inventors: Juergen Schmidt, Utzenfeld (DE); Guglielmo Pasetti, Lodi (IT); Tobias Beckenbauer, Utzenfeld (DE)

(21) Appl. No.: 18/431,349

(22) Filed: Feb. 2, 2024

Related U.S. Application Data
(60) Provisional application No. 63/442,930, filed on Feb. 2, 2023.
(60) Provisional application No. 63/592,701, filed on Oct. 24, 2023.

(51) Int. Cl. C08L 77/06; C08K 13/04

(52) U.S. Cl. CPC C08L 77/06; C08K 13/04; C08K 2201/019

(57) ABSTRACT

A polymer composition is disclosed that contains glass fibers and has an excellent balance of properties. The polymer composition displays a comparative tracking index of greater than about 400 volts and a dielectric strength of greater than about 4 kV/mm. In addition, the polymer composition results in excellent surface properties even when molding parts having a long length. The polymer composition can contain at least one stabilizer in combination with a calcium phosphate, such as a calcium hydroxyphosphate. In one aspect, the calcium phosphate is present in the polymer composition in the form of bone char.

### RELATED APPLICATIONS

The present application is based upon and claims priority to U.S. Provisional Application Ser. No. 63/442,930, having a filing date of Feb. 2, 2023 and U.S. Provisional Application Ser. No. 63/592,701, having a filing date of Oct. 24, 2023, both of which are incorporated herein by reference.

### BACKGROUND

Various electrical components, such as connectors and housings, have recently grown in importance due to the advent of the electric vehicle and the continuous advancement in other electronic components. Electric vehicles including hybrid vehicles, for instance, generally have an electric powertrain that contains an electric propulsion source, such as thousands of lithium ion battery cells, and at least one electric motor. The electric propulsion source provides a high voltage electrical current that is supplied to the motor via one or more power electronics modules. Consequently, electric vehicles require the use of many electrical connectors, housings for the connectors, and other electrical components that are used to convey the high voltage electrical current.

Polyamide compositions, especially when reinforced with glass fibers, are particularly well suited for producing electrical components and housings in electric vehicles and in other industrial applications. In some applications, flame retardancy is desired. Thus, various different flame retardant packages have been developed in the past for blending with polyamide compositions.

In other applications, however, high flame retardant standards may not be required. Some flame retardancy, however, is always desired including glow wire resistance. Other properties that may be important in certain applications include polymer compositions with high dielectric strength, high mechanical properties, and a relatively large operating temperature range, such as up to at least 110° C. The polymer compositions should also display some chemical resistance and, in certain applications, may desirably be laser markable.

Although various polyamide polymer compositions have been formulated in the past, a need still remains for an improved composition that has an excellent blend of properties as described above.

### SUMMARY

In general, the present disclosure is directed to a polyamide composition that displays a unique and beneficial blend of properties. Of particular advantage, the polyamide composition of the present disclosure can be formulated so as to display glow wire resistance, high dielectric strength, and a relatively high comparative tracking index. The composition can be formulated without including a flame retardant package.

For example, in one embodiment, the present disclosure is directed to a polymer composition containing at least one polyamide polymer, a plurality of inorganic fibers, and at least one stabilizer. In accordance with the present disclosure, the polymer composition contains a phosphate salt, such as calcium phosphate. In one aspect the phosphate salt is calcium hydroxyphosphate. The phosphate salt can be added by itself or can be added to the composition as a portion of a pigment, such as a black pigment. The black pigment, for instance, can comprise bone char. In one embodiment, a pigment can be incorporated into the composition containing a phosphate salt and further amounts of a phosphate salt can be added separately.

The polymer composition of the present disclosure can display a glow wire flammability index of about 900° C. or greater, such as about 960° C. or greater as determined in accordance with IEC-60695-2-12:2010 at a wall thickness of 1.5 mm. The composition can also exhibit a comparative tracking index of about 400 volts or greater, such as about 450 volts or greater, such as about 500 volts or greater, such as about 550 volts or greater, such as about 600 volts or greater as determined in accordance with IEC-60112:2003. The polymer composition can also display a dielectric strength of about 4 kV/mm or greater, such as about 5 kV/mm or greater at end of life. Dielectric strength can be measured according to ASTM Test D149-09.

Although unknown, it is believed that the phosphate salt, such as calcium hydroxyphosphate, is influencing one or more properties of the polymer composition in a beneficial manner. The phosphate salt, for instance, can be present in the polymer composition in an amount from about 0.01% by weight to about 4% by weight, such as from about 0.05% by weight to about 2.4% by weight, such as from about 0.05% by weight to about 1.2% by weight.

As described above, the black pigment incorporated into the polyamide composition can contain bone char from the bones of an animal, such as a mammal, and optionally carbon black. The bone char can be present in the polymer composition in an amount from about 0.01% by weight to about 4% by weight, such as from about 0.05% by weight to about 2.4% by weight, such as from about 0.05% by weight to about 1.2% by weight. The carbon black can be present in the polymer composition in relatively minor amounts, such as in amounts of from about 0.001% by weight to about 1% by weight, such as from about 0.001% by weight to about 0.5% by weight.

As described above, the polymer composition can contain at least one stabilizer. In one aspect, the stabilizer can be a hindered phenolic antioxidant. For instance, the hindered phenolic antioxidant can comprise N,N′-hexane-1,6-dlylbis(3-(3,5-di-tert,-butyl-4-hydroxyphenylpropionamide)). The hindered phenolic antioxidant can be present in the polymer composition generally in an amount from about 0.1% by weight to about 0.7% by weight, such as in an amount of from about 0.2% by weight to about 0.5% by weight.

In one aspect, the at least one stabilizer can be a phosphonite antioxidant. The phosphonite antioxidant can be present alone in the polymer composition or in combination with the hindered phenolic antioxidant. In one embodiment, the phosphonite antioxidant can have the following structure:

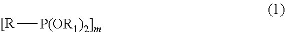

wherein, R is a mono- or polyvalent aliphatic, aromatic, or heteroaromatic organic radical; and R₁ is independently a compound of the structure (II)

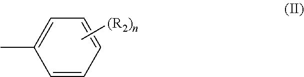

or the two radicals R₁ form a bridging group of the structure (III)

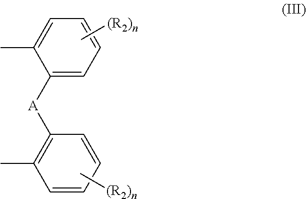

where A is a direct bond, O, S, C₁₋₁₈ alkylene (linear or branched), or C₁₋₁₈ alkylidene (linear or branched); R₂ is independently C₁₋₁₂ alkyl (linear or branched), C₁₋₁₂ alkoxy, or C₅₋₁₂ cycloalkyl; n is from 0 to 5, and m is from 1 to 4. In one embodiment, R is a cyclohexyl, phenyl, phenylene, or biphenyl radical, and R₁ a group of the structure (II) and wherein m is 2 and n is from 2 to 3.

The at least one stabilizer can also be a light stabilizer, such as a hindered amine light stabilizer. The light stabilizer can include one or more of the following general structures:

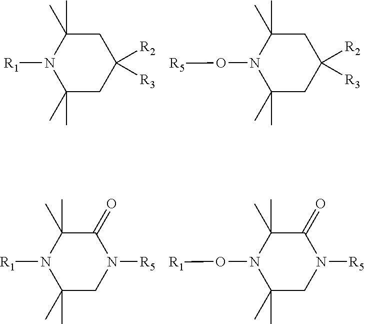

wherein, R₁, R₂, R₃, and R₅ are independently hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes, or any combination thereof.

In one embodiment, the hindered amine light stabilizer can include an alkyl substituted piperidyl compound. For example, the hindered amine light stabilizer can comprise N,N′-bis(2,2,6,6-tetramethyl-4-piperdinyl)-1,3-benzenedicarboxamide.

The polymer composition can also contain a metal oxide, such as silicon dioxide particles. The silicon dioxide particles can be present in the polymer composition in an amount from about 0.001% by weight to about 1.5% by weight, such as from about 0.001% by weight to about 0.3% by weight.

The polymer composition can also contain a lubricant. The lubricant can comprise a partially saponified ester wax of a C22 to C36 fatty acid.

One or more polyamides are generally present in the polymer composition in an amount from about 50% to about 90% by weight. The one or more polyamides present in the polymer composition can be one or more aliphatic polyamides alone or in combination with a semi-aromatic polyamide or a wholly aromatic polyamide. Aliphatic polyamides that may be present in the polymer composition include nylon-6, nylon-6,6, copolymers thereof, or combinations thereof.

The inorganic fibers present in the polymer composition can comprise glass fibers. The glass fibers can be present in an amount from about 5% by weight to about 50% by weight, such as from about 25% by weight to about 35% by weight. In one embodiment, the glass fibers can have an average fiber length of from about 150 microns to about 600 microns.

All different types of polymer articles can be molded from the polymer composition of the present disclosure. The polymer composition is particularly well suited to being molded into a component of an electrical device. The electrical device, for instance, can include an electrically conductive component surrounded by a molded polymer component formed from the polymer composition of the present disclosure. The molded polymer component can comprise a housing that surrounds the conductive component.

In one embodiment, the present disclosure can be directed to producing an electrical interface for an electric vehicle. The electrical interface can include an outer cover defining an interior space. The outer cover can be made from a flameproof material, such as aluminum. A polymer housing can be contained in the interior space of the outer cover. The polymer housing can be formed from the polymer composition as described above. The polymer housing, for instance, can be a junction box, a relay box, or any suitable E-box. In one embodiment, the polymer housing can comprise a baseplate, a housing cover attached to the baseplate, and one or more holder assemblies for holding electrical connectors within the housing.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of an electrical interface that may be made in accordance with the present disclosure;

FIG. 2 is a perspective view of a high voltage charging connector that may incorporate the polymer composition of the present disclosure;

FIG. 3 is a perspective view of a molded electrical housing made in accordance with the present disclosure, which may be used to enclose a lithium ion battery;

FIG. 4 is a perspective view of a battery plug board that may be made in accordance with the present disclosure; and

FIG. 5 is a perspective assembly view of one embodiment of a power distribution box that may employ the polymer composition of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

In general, the present disclosure is directed to a polyamide polymer composition that contains at least one polyamide resin in combination with reinforcing fibers. Although reinforcing fibers can improve the mechanical properties of polymer compositions, the presence of reinforcing fibers can adversely impact other properties, including the comparative tracking index. In this regard, various other additives and components are contained in the polymer composition in order to produce a polymer composition with excellent mechanical properties in combination with a beneficial blend of other properties, including a relatively high comparative tracking index. In accordance with the present disclosure, for instance, the polymer composition containing one or more polyamide polymers and reinforcing fibers can also contain at least one stabilizer, such as a blend of different stabilizers. In addition, the polymer composition can contain a calcium phosphate. The calcium phosphate can be present in a coloring agent (e.g. pigment) and/or added separately. The polymer composition can also contain one or more lubricants.

It was discovered that polymer compositions formulated in accordance with the present disclosure not only have good comparative tracking index properties but also produce parts with great surface appearance. Of particular advantage, large or long molded parts can be produced that have at least one dimension of greater than about 0.25 m, such as greater than about 0.5 m, such as greater than about 0.75 m, such as greater than about 1 m that have excellent surface quality and can display little to no warpage after molding or after being placed in use and exposed to high temperatures.

Polymer compositions formulated in accordance with the present disclosure can, for instance, operate in temperature ranges from −40° C. to greater than 110° C., such as up to 150° C. It is believed that the combination of the calcium phosphate and at least one stabilizer and optionally in combination with a lubricant can possibly control nucleation or crystallinity so that parts made from the polymer composition do not warp in high temperature environments. The polymer composition can display a comparative tracking index of generally greater than about 400 V, such as greater than about 450 V, such as greater than about 500 V, such as greater than about 550 V, such as even greater than 600 V. In fact, it was discovered that the polymer composition of the present disclosure can also maintain a relatively high comparative tracking index even after heat aging. For instance, after heat aging for 3,000 hours at 150° C., the polymer composition or molded articles made in accordance with the present disclosure can display a comparative tracking index that is still greater than about 500 V, such as greater than about 550 V, such as at 600 V or greater.

The dielectric strength of the polymer composition can also be greater than about 4 kV/mm, such as greater than about 4.5 kV/mm, such as greater than about 5 kV/mm, such as greater than about 5.5 kV/mm, and generally less than about 10 kV/mm, even when measured at end of life. The polymer composition can also display a glow wire resistance of greater than about 900° C., such as greater than about 920° C., such as greater than about 940° C., such as greater than about 960° C., and generally less than about 1,500° C. at a wall thickness of 1.5 mm.

In one embodiment, when the calcium phosphate is incorporated into a coloring agent, particularly a black pigment, polymer articles made from the polymer composition can be laser markable.

Of particular advantage, all of the above properties can be obtained without having to include a flame retardant in the formulation. For instance, in one embodiment, the polymer composition is free of phosphorous-based flame retardants and can be free of metal phosphinates, such as aluminum diethyl phosphinate. Even without containing flame retardants, the polymer composition can be formulated so as to display a HB flammability rating according to Underwriters Laboratory Test 94 at a thickness of 0.8 mm.

Due to the excellent flame resistance properties, excellent mechanical properties, and/or excellent thermal stability properties in combination with improved melt processing properties, the polymer composition of the present disclosure is well suited for making all different types of articles and components.

The polymer composition is particularly well suited for producing all different types of electrical components. Such components can include high voltage powertrain connectors, and/or charging connectors for electric vehicles and other devices that may be powered using lithium ion batteries. The polymer composition is also well suited to producing a housing for encasing an electrical component. In one embodiment, the polymer composition can be used to produce an electrical interface. The electrical interface, for instance, can be a relay box, a junction box, or any other suitable E-box. In one aspect, the polymer composition can be used to produce a polymer housing that is contained in the interior space of an outer case. The outer case can be made from a flame retardant material, such as aluminum. The housing can have relatively large dimensions, such as at least one dimension greater than about 0.5 m, such as from about 0.75 m to about 3 m, while having excellent surface properties and little to no warpage.

In general, any suitable polyamide can be incorporated into the polymer composition. The polymer composition, for instance, can include a single polyamide polymer or can include a mixture of different polyamide polymers.

In general, one or more polyamide polymers are present in the polymer composition in an amount from about 20% by weight to about 95% by weight, including all increments of 1% by weight therebetween. For example, the polymer composition may contain one or more polyamides in an amount greater than about 40% by weight, such as in an amount greater than about 50% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, and generally less than about 90% by weight, such as less than about 85% by weight, such as less than about 80% by weight, such as less than about 75% by weight.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-66 to nylon-6 is typically from 1 to about 2, in some embodiments from about 1.1 to about 1.8, and in some embodiments, from about 1.2 to about 1.6.

It is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonarnethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily aliphatic polyamide polymers that may be blended with one or more semi-aromatic polyamide polymers or a wholly aromatic polyamide polymer.

The polyamide employed in the polyamide composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

In one embodiment, the polyamide polymer incorporated into the polymer composition can comprise a post-industrial recycled polymer. For instance, the recycled polyamide polymer can be obtained from industrial fiber including tire cord, from carpet fiber, from textile fiber, from films, from fabrics including airbag fabrics, and the like. When incorporated into the polymer composition, the recycled polyamide polymers are optionally combined with virgin polymers. For example, the weight ratio between recycled polyamide polymers and virgin polyamide polymers can be from about 1:10 to about 10:1. For example, the amount of recycled polyamide polymer incorporated into the polymer composition can be greater than about 8% by weight, such as greater than about 10% by weight, such as greater than about 12% by weight, such as greater than about 15% by weight, such as greater than about 18% by weight, such as greater than about 20% by weight, such as greater than about 22% by weight, such as greater than about 30% by weight, such as greater than about 40% by weight, such as greater than about 50% by weight, such as greater than about 70% by weight, such as greater than about 80% by weight, such as greater than about 90% by weight, such as up to 100% by weight. The recycled polyamide is generally present in an amount less than about 90% by weight, such as in an amount less than about 70% by weight, such as in an amount less than about 50% by weight, such as in an amount less than about 45% by weight, such as less than about 35% by weight, such as less than about 30% by weight, based on the total amount of polyamide polymers present.

In addition to one or more polyamide polymers, the polymer composition of the present disclosure may contain reinforcing fibers, which can be inorganic fibers. For example, the reinforcing fibers or inorganic fibers can be present in the polymer composition generally in an amount greater than about 5% by weight, such as in an amount greater than about 10% by weight, such as in an amount greater than about 15% by weight, such as in an amount greater than about 20% by weight, such as in an amount greater than about 25% by weight. The reinforcing fibers or inorganic fibers can be present in the polymer composition generally in an amount less than about 50% by weight, such as in an amount less than about 45% by weight, such as in an amount less than about 40% by weight, such as in an amount less than about 35% by weight.

The inorganic fibers generally have a high degree of tensile strength relative to their mass. For example, the ultimate tensile strength of the fibers is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 150 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

The polymer composition of the present disclosure also contains a phosphate salt, such as a hydroxyphosphate salt. For example, the phosphate salt can be a hydroxyapatite. The phosphate salt, for instance, can be an alkaline or alkaline earth metal phosphate. In one particular embodiment, the phosphate salt comprises calcium phosphate, such as calcium hydroxyphosphate. It is believed that the phosphate salt can provide numerous advantages and benefits when incorporated into the polymer composition. Although unknown, it is believed that the phosphate salt may improve surface properties, may prevent warping, and, when combined with a pigment, preserve the color of the polymer composition. For instance, the phosphate salt may increase color stability. One or more phosphate salts can be present in the polymer composition in an amount greater than about 0.1% by weight, such as in an amount greater than about 0.3% by weight, such as in an amount greater than about 0.5% by weight, such as in an amount greater than about 0.7% by weight, such as in an amount greater than about 0.9% by weight, such as in an amount greater than about 1.1% by weight. The phosphate salt may be present in the polymer composition in an amount less than about 4.2% by weight, such as in an amount less than about 3% by weight, such as in an amount less than about 2.4% by weight, such as in an amount less than about 2% by weight, such as in an amount less than about 1.8% by weight, such as in an amount less than about 1.4% by weight, such as in an amount less than about 1.2% by weight, such as in an amount less than about 1% by weight.

In one embodiment, the phosphate salt, such as the calcium hydroxyphosphate, can be contained in a coloring agent that is incorporated into the polymer composition. The coloring agent, for instance, can be a black pigment. In one embodiment, the calcium phosphate or calcium hydroxyphosphate may be contained in a pigment with bone char. The bone black pigment, for instance, can be produced by the destructive distillation of animal bones in the absence of oxygen to form bone char. The bone char can have an average particle size of from about 0.3 microns to about 50 microns. The bone black pigment can comprise from about 10% to about 20% by weight carbon and from about 90% to about 80% by weight calcium phosphate. The calcium phosphate, for instance, can be incorporated into the polymer composition solely contained within the bone char or can be also added separately to the polymer composition. In one embodiment, for instance, bone char can be incorporated into the polymer composition in combination with additional amounts of a calcium phosphate.

The bone char can be present in the polymer composition generally in an amount greater than about 0.1% by weight, such as in an amount greater than about 0.3% by weight, such as in an amount greater than about 0.5% by weight, such as in an amount greater than about 0.7% by weight, such as in an amount greater than about 0.9% by weight, such as in an amount greater than about 1.1% by weight. The phosphate salt may be present in the polymer composition in an amount less than about 6% by weight, such as in an amount less than about 4.5% by weight, such as in an amount less than about 2.4% by weight, such as in an amount less than about 2% by weight, such as in an amount less than about 1.8% by weight, such as in an amount less than about 1.4% by weight, such as in an amount less than about 1.2% by weight, such as in an amount less than about 1% by weight.

In one aspect, the bone char can contain from about 70% to about 96% by weight calcium hydroxyphosphate and essentially the remainder of the composition can comprise carbon black. For instance, carbon black can be in the bone char in an amount from about 4% by weight to about 30% by weight.

As described above, calcium hydroxyphosphate can be added to the polymer composition solely in the form of the bone char. Alternatively, calcium hydroxyphosphate can be added separately from the bone char. In still another embodiment, calcium hydroxyphosphate can be incorporated into the composition by not only adding bone char, but by also adding further amounts of a calcium hydroxyphosphate source.

In one aspect, the polymer composition contains calcium hydroxyphosphate in an amount from about 0.3% by weight to about 4.2% by weight, including all increments of 0.1% by weight therebetween. The proportion of the calcium hydroxyphosphate present in the polymer composition that has been added in the form of bone char can be in the amount of from about 0% by weight to about 100% by weight (based on the total amount of calcium hydroxyphosphate present in the composition). For instance, the proportion of calcium hydroxyphosphate contained in the polymer composition in the form of bone char can be greater than about 20% by weight, such as greater than about 40% by weight, such as greater than about 60% by weight, such as greater than about 80% by weight. The proportion of calcium hydroxyphosphate present in the polymer composition in a form other than bone char (such as in a pure form) can also be from about 0% by weight to about 100% by weight. For example, the proportion of calcium hydroxyphosphate present in the polymer composition added not as bone char can be present in an amount greater than about 20% by weight, such as in an amount greater than about 40% by weight, such as in an amount greater than about 60% by weight, such as in an amount greater than about 80% by weight, and can be present as a proportion of the calcium hydroxyphosphate in an amount less than about 90% by weight, such as in an amount less than about 70% by weight, such as in an amount less than about 50% by weight, such as in an amount less than about 30% by weight.

As described above, carbon black can also be incorporated into the polymer composition in the form of bone char. Carbon black can also be added separately to the polymer composition. The total amount of carbon black present in the polymer composition is generally greater than about 0.001% by weight, such as greater than about 0.01% by weight, such as in an amount greater than about 0.1% by weight, such as in an amount greater than about 0.3% by weight, such as in an amount greater than about 0.5% by weight, such as in an amount greater than about 0.7% by weight, and generally in an amount less than about 1% by weight, such as in an amount less than about 0.7% by weight, such as in an amount less than about 0.5% by weight. Although carbon black can produce a polymer composition with a desired overall black color, carbon black can also deteriorate the comparative tracking index of the overall composition. It is believed, however, that the calcium hydroxyphosphate counteracts the effects of carbon black and maintains the comparative tracking index at relatively high levels, such as about 600 V or greater.

Incorporating bone char into the polymer composition of the present disclosure can also provide various functional benefits above and beyond being used as a black pigment or supplementing the amount of calcium phosphate. For instance, bone char can render the polymer composition laser markable when molded into an article. Once exposed to laser light, for instance, bone char pigment can change in color, such as to a white color.

The polymer composition can also contain various other components and additives. For instance, the polymer composition can contain one or more stabilizers. One example of a stabilizer that can be incorporated into the polymer composition is a heat stabilizer that comprises a hindered phenolic antioxidant.

Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethyl benzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyidiphenamine (Naugalube® 438R); phosphonic acid, (3,5-ditert-butyl-4-hydroxybenzyl)-,dioctadecyl ester (Irganox® 1093); 1,3,5-trimethyl-2,4,6-tris(3′5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® OS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol](Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like.

In one embodiment, the phenolic antioxidant can be N,N′-hexane-1,6-dlylbis(3-(3,5-di-tert,-butyl-4-hydroxyphenylpropionamide)).

One or more hindered phenolic antioxidants can be present in the polymer composition generally in an amount greater than about 0.01% by weight, such as in an amount greater than about 0.10% by weight, such as in an amount greater than about 0.2% by weight, such as in an amount greater than about 0.25% by weight, and generally less than about 2% by weight, such as less than about 0.8% by weight, such as less than about 0.5% by weight.

In one aspect, the polymer composition may also contain a phosphorous-containing antioxidant. The phosphorous-containing antioxidant may include, for instance, a phosphonite having the structure:

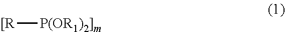

wherein,
R is a mono- or polyvalent aliphatic, aromatic, or heteroaromatic organic radical, such as a cyclohexyl, phenyl, phenylene, and/or biphenyl radical; and
R₁ is independently a compound of the structure (II)

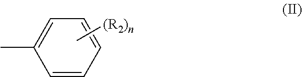

or the two radicals R₁ form a bridging group of the structure (III)

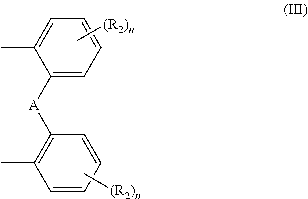

where
A is a direct bond, O, S, C₁₋₁₈ alkylene (linear or branched), or C₁₋₁₈ alkylidene (linear or branched);
R₂ is independently C₁₋₁₂ alkyl (linear or branched), C₁₋₁₂ alkoxy, or C₅₋₁₂ cycloalkyl;
n is from 0 to 5, in some embodiments from 1 to 4, and in some embodiments, from 2 to 3, and
m is from 1 to 4, in some embodiments from 1 to 3, and in some embodiments, from 1 to 2 (e.g., 2).

Particular preference is given to compounds which, on the basis of the preceding claims, are prepared via a Friedel-Crafts reaction of an aromatic or heteroaromatic system, such as benzene, biphenyl, or diphenyl ether, with phosphorus trihalides, preferably phosphorus trichloride, in the presence of a Friedel-Crafts catalyst, such as aluminum chloride, zinc chloride, iron chloride, etc., and a subsequent reaction with the phenols underlying the structures (II) and (Ill). Mixtures with phosphites produced in the specified reaction sequence from excess phosphorus trihalide and from the phenols described above are expressly also covered by the invention.

In one particular embodiment, R₁ is a group of the structure (II). Among this group of compounds, antioxidants of the general structure (V) are particularly suitable:

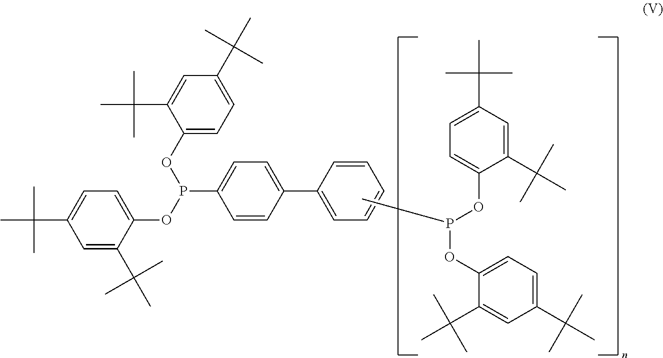

wherein, n is as defined above.

In one particular embodiment, for instance, n in formula (V) is 1 such that the antioxidant is tetrakis(2,4-di-tert-butylphenyl)4,4′-biphenylene-diphosphonite.

In one embodiment, the antioxidant can be a reaction product of 2,4-di-tert-butylphenol, phosphorous trichloride, and 1,1′-biphenyl.

The phosphorous-containing antioxidant or phosphonite can be present in the polymer composition in an amount greater than about 0.01% by weight, such as in an amount greater than about 0.05% by weight, such as in an amount greater than about 0.08% by weight, such as in an amount greater than about 0.12% by weight, such as in an amount greater than about 0.15% by weight, such as in an amount greater than about 0.18% by weight. The phosphorous-containing antioxidant is generally present in an amount less than about 2% by weight, such as in an amount less than about 1% by weight, such as in an amount less than about 0.8% by weight, such as in an amount less than about 0.6% by weight, such as in an amount less than about 0.4% by weight.

Another stabilizer that can be present in the polymer composition is a hindered amine light stabilizer. Examples of light stabilizers that may be incorporated into the present disclosure include a benzendicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2,6,6-tetramethyl piperidine. Preferred specific examples of HALS include: ˜2,2,6,6-tetramethyl-4-piperidinone, ˜2,2,6,6-tetramethyl-4-piperidinol, ˜bis-(2,2,6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro [5.1.11.2] heneicosane-20-propionic acid dodecylester and 2.2.4.4 tetramethyl-21-oxo-7; oxa-3,20-diazadispiro [5,1,11,2]-heneicosane-20-propionic acid; tetradecyl ester, ˜diacetam 5 (CAS registration number: 76505-58-3), ˜propanedioic acid, [(4-methoxyphenyl) methylene]-, bis(1,2,2,6,6-pentamethyl-4-piperidinyl) ester, ˜1,3-benzendicarboxamide, N,N′-bis (2,2,6,6-tetramethyl-4-piperidinyl), ˜3-dodecyl-1-(2,2,6,6-tetramethyl-4-piperidyl)-pyrrolidin-2,5-dione, ˜formamide, N,N′-1,6-hexanediylbis [N-(2,2,6,6-tetramethyl-4-piperidinyl, ˜3-dodecyl-1-(1,2,2,6,6-pentamethyl-4-piperidyl)-pyrrolidin-2,5-dione, ˜1,5-Dioxaspiro (5,5) undecane 3,3-dicarboxylic acid, bis (2,2,6,6-tetramethyl-4-peridinyl) ester, ˜1,5-Dioxaspiro (5,5) undecane 3,3-dicarboxylic acid, bis (1,2,2,6,6-pentamethyl-4-peridinyl) ester, ˜bis (1,2,2,6,6-penta methyl-4-piperidyl)(3,5-di-t-butyl-4-hydroxybenzyl)-butylpropanedioate, ˜tetrakis-(1,2,2,6,6-penta-methyl-4-piperidyl)-1,2,3,4-butane-tetra- -carboxylate, ˜1,2,3,4-butanetetracarboxylic acid, tetrakis(2,2,6,6-tetramethyl-4-piperidinyl) ester, ˜1,2,3,4-butane-tetracarboxylic acid-1,2,3-tris (1,2,2,6,6-pentamethyl-4-piperidinyl)-4-tridecylester, ˜8-acetyl-3-dodecyl-7,7,9,9-tetra methyl-1,3,8-triazaspiro (4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, ˜1,5,8,12-tetrakis [2′,4′-bis (1″,2″,2″,6″,6″-pentamethyl-4″-piperidinyl(butyl)amino)-1′,3′,5′-tr-iazin-6′-yl]-1,5,8,12-tetraazadodecane, ˜1,1′-(1,2-ethane-di-yl)-bis-(3,3′,5,5′-tetra-methyl-piperazinone) (Good rite 3034), ˜propane amide, 2-methyl-N-(2,2,6,6-tetramethyl-4-piperidinyl)-2-[(2,2,6,6-tetramethyl-4-piperidinyl)amino], ˜oligomer of N-(2-hydroxyethyl)-2,2,6,6-tetramethyl-4-piperidinol and succinic acid, ˜poly [[6-[(1,1,3,3-tetramethylbutyl)amino]-s-triazine-2,4-diyl][2,2,6,6-tetram-ethyl-4-piperidinyl)imino]hexamethylene [(2,2,6,6-tetramethyl-4-piperidinyl)imino]], ˜poly [(6-morfoline-S-triazine-2.4-diyl) [(2.2.6.6-tetramethyl-4-piperidinyl)-imino]hexamethylene-[(2.2.6.6-tetram-ethyl-4-piperidinyl)-imino]], ˜poly [(6-morpholino-s-triazine-2.4-diyl) [1.2.2.6.6-penta-methyl-4-piperidyl) imino]-hexamethylene [(2,2,6,6 tetra-methyl-4-piperidyl) imino]], ˜poly methylpropyl-3-oxy-[4(2.2.6.6-tetrametyl)-piperidinyl)]-siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro [5,5] undecane-3,9-diethanol, 1,2,2,6,6-pentamethyl-4-piperidinyl ester, ˜1,2,3,4-butanetetracarboxylic acid, polymer with 8,8,8′,8′-tetramethyl-2,4,8,10-tetraoxaspiro [5,5] undecane-3,9-diethanol, 2,2,6,6-tetramethyl-4-piperidinyl ester, ˜oligomer of 7-Oxa-3,20-diazadispiro [5,1,11,2] heneicosan-21-one, 2,2,4,4-tetramethyl-20-(oxiranylmethyl), ˜1,3,5-Triazine-2,4,6-triamine, N, N″-[1,2-ethanediylbis [[[4,6-bis[butyl(1,2,2,6,6-pentamethyl-4-iperidinyl)amino]-1,3,5-triazine- -2-yl]imino]-3,1-propanediyl]]-bis [N. N″-dibutyl-N. N″-bis (1.2.2.6.6-pentamethyl-4-piperidinyl), ˜1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′-bis (2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo [21,3,1,110,14]octacosa-1(27), 10,12,14(28), 23,25-hexaene-12,25-diamine, N,N′-bis (1,1,3,3-tetramethylbutyl)-2,9,15,22-tetrakis (2,2,6,6-tetramethyl-4-piperidinyl)-, ˜1,1,1″-(1,3,5-Triazine-2,4,6-triyltris ((cyclohexylimino)-2,1-ethanediyl) tris (3,3,5,5-tetramethylpiperazinone), ˜1,1,1″-(1,3,5-Triazine-2,4,6-triyltris((cyclohexylimino)-2,1-ethylenediyl) tris (3,3,4,5,5-tetramethylpiperazinone), ˜1,6-hexanediamine, N, N′-bis (2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C20-24)-4 alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine; HALS PB-41 or mixtures thereof.

In one particular embodiment, the hindered amine light stabilizer includes an alkyl-substituted piperidyl compound. For example, the compound may be a di- or tri-carboxylic (ester) amide, such as N,N′-bis(2,2,6,6-tetramethyl-4-piperdiyl)-1,3-benzenedicarboxamide (Nylostab® S-EED).

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

In one embodiment, the polyamide polymer composition can also contain a lubricant. Any suitable lubricant can be incorporated into the polymer composition. In one aspect, the lubricant can comprise a partially saponified ester wax. For example, the lubricant can comprise a partially saponified ester wax of a C22 to C36 fatty acid. The fatty acid, for instance, can comprise a montan wax. In one aspect, the lubricant can contain 1-methyl-1,3-propanediyl esters. The wax can have an acid value of from about 9 mgKOH/g to about 14 mgKOH/g.

The lubricant can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 2.5% by weight, such as in an amount less than about 2% by weight, such as in an amount less than about 1.5% by weight, such as in an amount less than about 1% by weight, such as in an amount less than about 0.8% by weight.

Another component that may be optionally contained in the polymer composition is metal oxide particles, such as silicon dioxide particles. The metal oxide particles or silicon dioxide particles can be present in relatively minor amounts. For instance, the particles can be present in the polymer composition in an amount greater than about 0.001% by weight, such as in an amount greater than about 0.005% by weight, such as in an amount greater than about 0.008% by weight, such as in an amount greater than about 0.01% by weight, such as in an amount greater than about 0.03% by weight. The particles are generally present in an amount less than about 1.5% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

A wide variety of additional additives can also be included in the polyamide composition, such as impact modifiers, compatibilizers, particulate fillers (e.g., mineral fillers), pigments, and/or other materials added to enhance properties and processability.

In one embodiment, the polymer composition is formulated so as to have some burn control properties. For instance, the polymer composition can display slow horizontal burning on a 0.8 mm thick specimen with a burning rate that is less than about 3 inches per minute or stops burning before the 5 inch mark. For instance, the polymer composition can display an HB rating according to UL 94. These properties can be displayed by the polymer composition without containing a flame retardant. For instance, the polymer composition, in one embodiment, may be free of phosphorous-based flame retardants. For example, the polymer composition can be formulated to be free of metal phosphonates, such as aluminum diethylphosphonate.

Alternatively, one or more flame retardants can be incorporated into the polymer composition. For instance, the polymer composition may contain a metal phosphinate as described above in combination with a nitrogen synergist and zinc borate. The nitrogen synergist, for instance, can be a melamine polyphosphate.

The polyamide, inorganic fibers, and other additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The fibers may optionally be added a location downstream from the point at which the polyamide is supplied (e.g., hopper). If desired, a flame retardant(s) may also be added to the extruder a location downstream from the point at which the polyamide is supplied. One or more of the sections of the extruder are typically heated, such as within a temperature range of from about 200° C. to about 450° C., in some embodiments, from about 220° C. to about 350° C., and in some embodiments, from about 250° C. to about 350° C. to form the composition. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

Regardless of the particular manner in which it is formed, the resulting polyamide composition can possess excellent thermal properties. For example, the melt viscosity of the polyamide composition may be low enough so that it can readily flow into the cavity of a mold having small dimensions. In one particular embodiment, the polyamide composition may have a melt viscosity of from about 400 to about 1,000 Pascal-seconds (“Pa-s”), in some embodiments from about 450 to about 900 Pa-s, and in some embodiments, from about 500 to about 800 Pa-s, determined at a shear rate of 1000 seconds⁻¹. Melt viscosity may be determined in accordance with ISO Test No. 11443:2005 at a temperature that is 15° C. higher than the melting temperature of the composition (e.g., 285° C.).

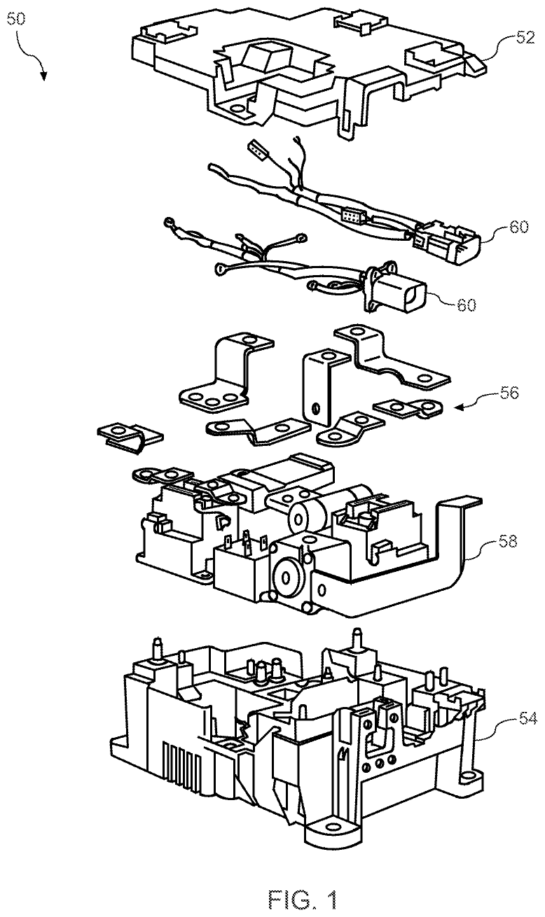

The polyamide polymer composition of the present disclosure can be used to produce all different types of molded components and parts. Examples of articles that can incorporate the polymer composition are illustrated in FIGS. 1-5. Referring to FIG. 1, for instance, one embodiment of a junction box, a relay box, or other E-box 50 is shown. The E-box 50 can form part of an electrical interface that includes an optional outer cover that goes over the entire assembly as shown in FIG. 1. The optional outer cover, for instance, can be made from a flame retardant material, such as aluminum, and can define an interior space. The E-box 50 can be contained within the interior space of the outer cover.

As shown, the E-box 50 includes a housing cover 52 that attaches to a baseplate 54. The E-box 50 can further include various internal components 56 including a holder assembly 58. The holder assembly 58 is for holding various different electrical components, such as electrical connectors 60. The E-box 50 can be made from the polymer composition of the present disclosure. For instance, the entire E-box assembly can be made from the polymer composition or various components can be made from the polymer composition.

The E-box 50 can serve as an electrical interface to an electric vehicle. For instance, E-box 50 can serve as an energy and load management device for a battery system. The E-box 50 can be contained within the battery system of an electric vehicle and may be positioned, for instance, on top of the battery modules.

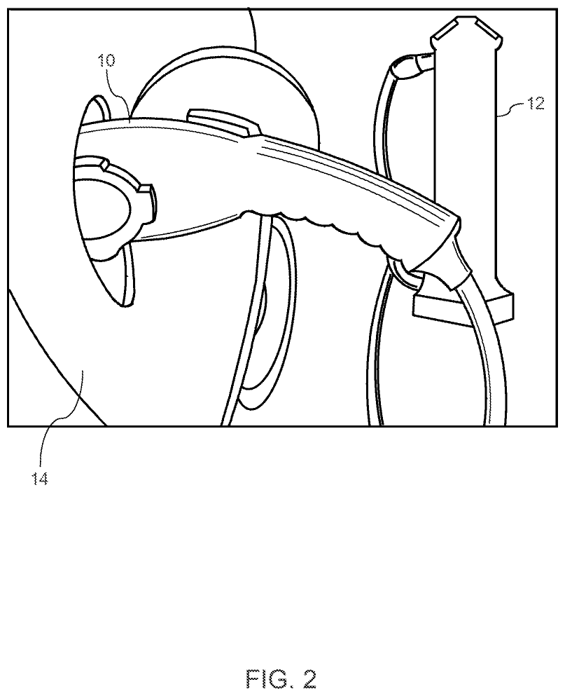

Referring now to FIG. 2, a high voltage charging plug or connector 10 is illustrated. As shown, the charging plug 10 is in electrical communication with a voltage source 12 and is connected to an electric vehicle 14. The charging plug or connector 10 can include a connector portion that includes an electrical pin that makes an electrical connection with a high voltage circuit contained within the electric vehicle 14. A protection or insulating member extends from a base and surrounds at least a portion of the electrical pin contained within the charging plug 10. At least the base of the protection member can be comprised of the polymer composition of the present disclosure. The polymer composition of the present disclosure can also be used to produce various other components contained within the charging plug 10.

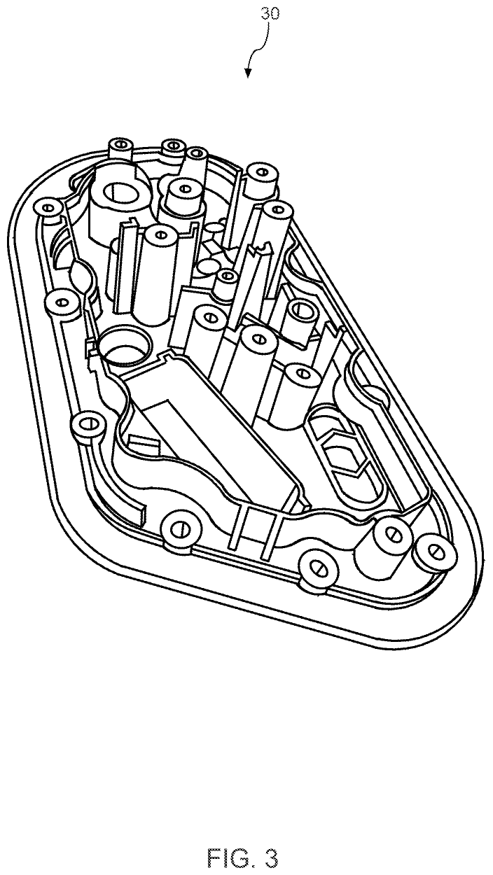

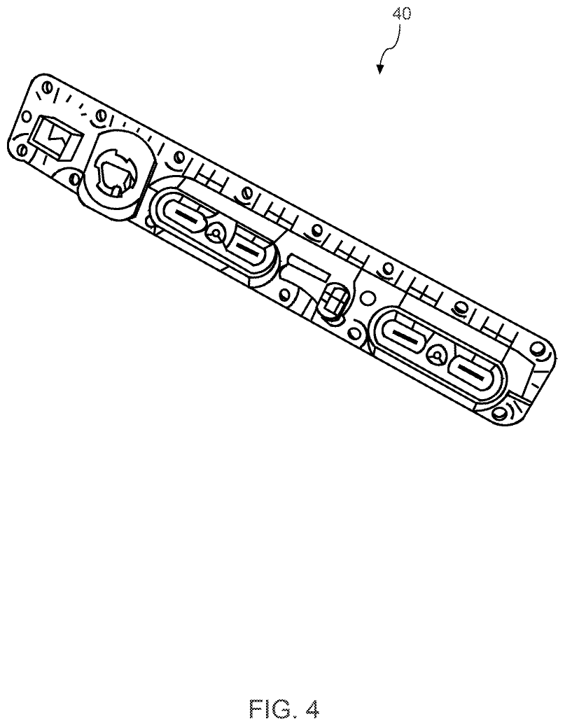

In one embodiment, the polymer composition of the present disclosure can also be used to produce other housings that contain electrical components. For example, referring to FIG. 3, a portion of a battery housing 30 is shown. The battery housing 30 can include various different complex shapes that can all be molded from the polymer composition of the present disclosure. Similarly, FIG. 4 illustrates a battery plug board 40 that can also be molded from the polymer composition of the present disclosure. The battery plug board 40 can, in one embodiment, form a portion of the housing of the battery and can be used to connect the battery to an electrical connector.

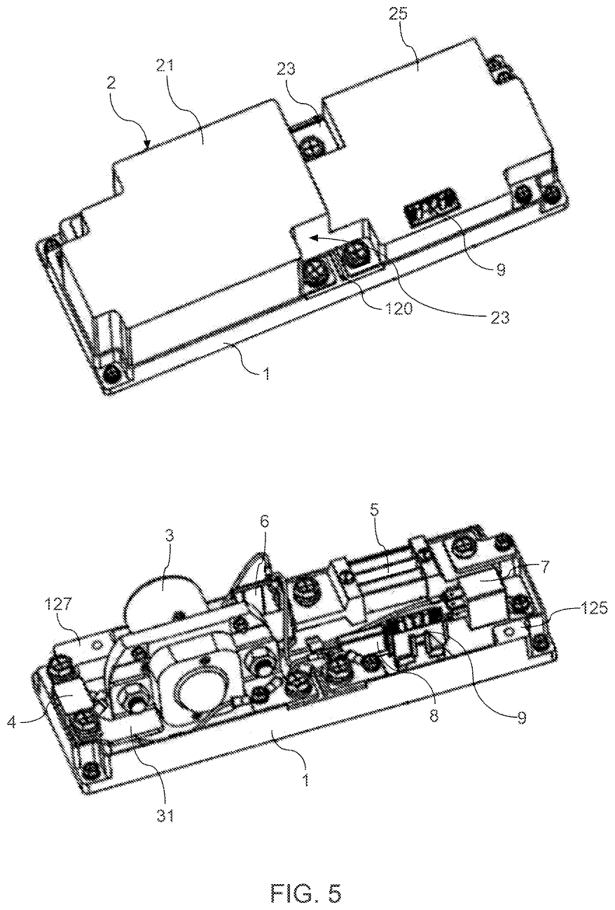

Apart from the structures shown in FIGS. 1 through 4, various other electric components, especially well suited for electric vehicles, may also employ the polymer composition of the present disclosure. In FIG. 5, for example, one embodiment of a battery system is shown that includes, for example, a main relay 3, main fuse 4, shunt 5, heating relay 6, pre-charging relay 7, and a pre-charging resistor 8. The system may also include a relay box that, in this particular embodiment, is formed from a housing that includes a base 1 and an upper cover 2. Of course, it should also be understood that the box may be an integral component, or may contain other portions. If desired, the base 1 and/or upper cover 2 may be made from the polymer composition of the present disclosure.

In the illustrated embodiment, the positive circuit includes the main relay 3 and the main fuse 4 connected in series. The main fuse 4 is electrically connected to the positive output terminal of the battery module (not shown). The upper cover 2 includes a first box cover 21 and a second box cover 25 that communicate with each other, the first box cover 21 covers a first area and the second box cover 25 covers a second area. The first box cover 21 and the second box cover 25 may be connected to form a stepped structure, so that the resulting box has a regular shape. The main fuse 4 may be connected in series with the main relay 3 through a connection row 31 to form a positive circuit, so that the input row of the positive circuit is fixedly supported on the first boss.

The outer side walls of the upper cover 2 have inwardly recessed grooves 23 at corner positions and the positions where the first box cover 21 and the second box cover 25 are connected. The grooves 23 in the upper left corner of the first box cover 21 give way to the input row of the positive circuit, and the grooves 23 in the upper left corner and the upper right corner of the second box cover 25 respectively give way to the input row and output row of the negative circuit. Further, the upper cover 2 and the base 1 are fixedly connected by bolts. Specifically, the diagonal positions of the accommodating groove have bosses 125 and bosses 127, and the diagonal positions of the upper cover 2 are recessed inward to form installation grooves. Preferably, a partition plate 120 is provided on the combination boss and located between the input row of the heating circuit and the output row of the positive circuit, so as to realize the physical insulation of the heating circuit and the positive circuit, and improve the reliability of the power distribution box. In addition, the box further includes an adapter plug 9. The positive circuit, the negative circuit, the heating circuit, and the pre-charging circuit are all connected to an external control unit through the adapter plug 9 for communication, which avoids the chaotic wiring inside the box and reduces the usage of the wiring harness.

### Example

The present disclosure may be better understood with reference to the following example.

### Test Methods for Examples

Tensile Modulus, Tensile Stress, and Tensile Elongation at Break: Tensile properties may be tested according to ISO 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Comparative Tracking Index (“CTI”): The comparative tracking index (CTI) may be determined in accordance with International Standard IEC 60112-2020 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm or as specified. The two sets are conditioned before and after aging. For unaged testing, each thickness is tested after conditioning for 48 hours at 2300 and 50% relative humidity. For aged testing, five (5) samples of each thickness are tested after conditioning for 7 days at 70° C.

The following is one embodiment of a polymer formulation in accordance with the present disclosure.

| | Sample |
|---|---|
| Component | % |
| Polyamide 6 or Polyamide 6,6 | 63.85 |
| Glass fibers | 30 |
| N,N′-hexane-1,6-dlylbis(3-(3,5-di-tert,-butyl-4- | 0.3 |
| hydroxyphenylpropionamide)) | |
| Partially saponified ester wax of montanic acid | 0.5 |
| N,N′-bis(2,2,6,6-tetramethyl-4-piperdinyl)-1,3- | 0.1 |
| benzenedicarboxamide | |
| Tetrakis(2,4-di-tert-butylphenyl)4,4′- | 0.2 |
| biphenylene-diphosphonite | |
| Silicon dioxide particles | 0.05 |
| Calcium hydroxyphosphate | 0.1%-0.8% |
| Bone char | 0.1%-0.8% |
| Carbon | 0.1% |
| UL94 @0.8 mm | HB |
| CTI (volts) | 600 |
| Dielectric strength (kV/mm) | 4.5 (unconditioned) |
| | and >10 (conditioned) |
| Tensile strength (MPa) | 170 |

As shown above, the sample displayed an extraordinary balance of properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A polymer composition comprising at least one polyamide polymer, a plurality of inorganic fibers, at least one stabilizer, and a phosphate salt, wherein the composition exhibits:
a Glow Wire Flammability Index of about 900° C. or more as determined in accordance with IEC-60695-2-12:2010 at a wall thickness of 1.5 mm;
a comparative tracking index of about 600 volts or more as determined in accordance with IEC 60112:2003; and
a dielectric strength of 4 kV/mm or greater.

2. A polymer composition as defined in claim 1, wherein the phosphate salt comprises calcium hydroxyphosphate and is present in the composition in an amount from about 0.01% by weight to about 4% by weight.

3. A polymer composition as defined in claim 1, wherein the composition comprises bone char from the bones of an animal.

4. A polymer composition as defined in claim 3, wherein the bone char is present in the polymer composition in an amount from about 0.01% by weight to about 4% by weight.

5. A polymer composition as defined in claim 1, wherein the composition comprises carbon black in an amount from about 0.001% by weight to about 1% by weight.

6. A polymer composition as defined in claim 1, wherein the at least one stabilizer comprises a hindered phenolic antioxidant.

7. A polymer composition as defined in claim 6, wherein the hindered phenolic antioxidant comprises N,N′-hexane-1,6-dlylbis(3-(3,5-di-tert,-butyl-4-hydroxyphenylpropionamide)).

8. A polymer composition as defined in claim 6, wherein the hindered phenolic antioxidant is present in the polymer composition in an amount from about 0.1% by weight to about 0.7% by weight.

9. A polymer composition as defined in claim 1, wherein the at least one stabilizer comprises a phosphonite having the structure: 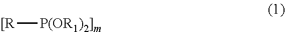
wherein,
R is a mono- or polyvalent aliphatic, aromatic, or heteroaromatic organic radical; and
R₁ is independently a compound of the structure (II) 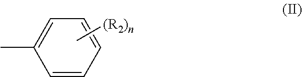
or the two radicals R₁ form a bridging group of the structure (III) 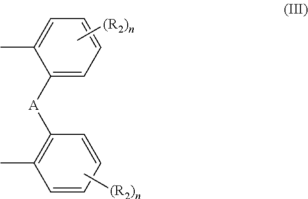
where
A is a direct bond, O, S, C₁₋₁₈ alkylene (linear or branched), or C₁₋₁₈ alkylidene (linear or branched);
R₂ is independently C₁₋₁₂ alkyl (linear or branched), C₁₋₁₂ alkoxy, or C₅₋₁₂ cycloalkyl;
n is from 0 to 5, and
m is from 1 to 4.

10. A polymer composition as defined in claim 1, further comprising silicon dioxide particles present in an amount from about 0.001 wt. % to about 1.5 wt. %.

11. A polymer composition as defined in claim 1, further comprising a lubricant.

12. A polymer composition as defined in claim 11, wherein the lubricant comprises a partially saponified ester wax of a C22 to C36 fatty acid.

13. A polymer composition as defined in claim 1, wherein the at least one polyamide polymer constitutes from about 50 wt. % to about 80 wt. % of the composition, and the inorganic fibers constitute from about 5 wt. % to about 50 wt. % of the composition.

14. A polymer composition as defined in claim 1, wherein the polymer composition does not contain a phosphorous flame retardant.

15. A polymer composition as defined in claim 1, wherein the polymer composition does not contain a metal phosphinate.

16. A polymer composition as defined in claim 1, wherein the polyamide polymer is an aliphatic polyamide polymer.

17. A polymer composition as defined in claim 16, wherein the aliphatic polyamide polymer is nylon-6, nylon-6,6, a copolymer thereof, or a combination thereof.

18. A polymer composition as defined in claim 17, wherein the aliphatic polyamide polymer is present with a semi-aromatic polyamide polymer or a wholly aromatic polyamide polymer.

19. A polymer composition as defined in claim 1, wherein the inorganic fibers include glass fibers and are present in the polymer composition in an amount of from about 25 wt. % to about 35 wt. %, the glass fibers having an average fiber length of from about 150 microns to about 600 microns.

20. A polymer composition as defined in claim 1, wherein the polymer composition is laser markable.

21. An electrical interface for an electric vehicle comprising:
an outer cover defining an interior space; and
a polymer housing contained in the interior space of the outer cover, the polymer housing being formed from a polymer composition as defined in claim 1.
